(19) United States
(12) Patent Application Publication
(10) Pub. No.: US 2006/0205243 A1
(43) Pub. Date: Sep. 14, 2006

(54) Pitch converting connector and method of manufacture thereof

(76) Inventors: Katsuhiko Sakamoto, Kanagawa (JP); Noriharu Kurokawa, Kanagawa (JP)

Correspondence Address: BARLEY SNYDER, LLC, 1000 WESTLAKES DRIVE, SUITE 275, BERWYN, PA, 19312, US

(21) Appl. No.: 11/372,798

(22) Filed: Mar. 10, 2006

(30) Foreign Application Priority Data
Mar. 11, 2005 (JP) 2005-69291

(51) Int. Cl. H01R 12/00

(52) U.S. Cl. 439/66

(57) ABSTRACT

A pitch converting connector is equipped with a ceramic circuit board, formed by a plurality of ceramic green sheets, which are stacked in the thickness direction thereof and sintered. A plurality of conductive paths are formed on a surface of each ceramic green sheet, such that they are provided at a narrow pitch at a first end of the ceramic green sheet, and widen to a wide pitch at a second end thereof. Electrodes are formed on the conductive paths, which are exposed at the first and second ends of the ceramic circuit board.

### FIELD OF THE INVENTION

The present invention relates to a pitch converting electrical connector and a manufacturing method thereof. Particularly, the present invention relates to a pitch converting connector, which is interposed between electric/electronic devices for connecting wires with narrow pitch connection points.

### BACKGROUND OF THE INVENTION

Japanese Unexamined Patent Publication No. 9(1997)-092365 discloses a pitch converting connector known as a relay connector. This pitch converting connector comprises insulative plates, on each of which wiring is formed and adhesive insulative plate elements made of thermosetting adhesive resin. The insulative plates and the adhesive insulative plate elements are alternately stacked over the thickness thereof, then pressurized in the stacking direction while applying heat, to cause the plates to adhere to each other. The insulative plates are formed by resin, and the wiring is formed to be of a narrow pitch at a first end of the connector, and a wide pitch at a second end thereof.

Japanese Unexamined Patent Publication No. 10(1998)-303525 discloses a wired circuit board. This wire circuit board comprises an insulative layer and a plurality of metallic wire members. The metallic wire members penetrate through the insulative layer such that the ends thereof are exposed at both sides of the insulative layer. In addition, the wire members are provided such that each row of wire members is at a different angle with respect to the plane of the insulative layer.

The pitch converting connector of Japanese Unexamined Patent Publication No. 9(1997)-092365 is formed by stacking the insulative plates and the adhesive insulative plate elements alternately over the thickness thereof, then pressurizing the stack in the stacking direction while applying heat, to cause the plates to adhere to each other. When thermosetting conductive adhesive is employed to adhesively attach conductive pins of a pitch converting connector to a piezoelectric element of an ultrasound probe, an ambient temperature of approximately 150° C. is required. The temperature necessary for thermosetting may become higher, depending on the shapes of the parts to be adhesively attached. For this reason, there is a possibility that the resin components of pitch converting connectors constituted by resin insulative plates, such as that disclosed in Japanese Unexamined Patent Publication No. 9(1997)-092365, will deform due to heat during the manufacturing process. Therefore, these pitch converting connectors are not suited for narrow pitch/multiple pin applications.

The wired circuit board disclosed in Japanese Unexamined Patent Publication No. 10(1998)-303525 is formed such that the angle of each row of wires differs with respect to the plane of each of the insulative layers that constitute the multi layered wired circuit board. Therefore, the wired circuit board is difficult to manufacture.

### SUMMARY

The present invention has been developed in view of the circumstances described above. It is an object of the present invention to provide a reliable pitch converting connector that does not deform due to heat applied thereto during or after the manufacturing process, and a manufacturing method thereof.

It is another object of the present invention to provide a pitch converting connector which is easy to manufacture, and a manufacturing method thereof.

The pitch converting connector of the present invention comprises: a ceramic circuit board formed of a plurality of ceramic green sheets and a plurality of conductive paths, which are formed from a first end to a second end of the ceramic green sheets such that they are at a narrow pitch at the first end and widen to a wide pitch at the second end. The plurality of ceramic green sheets are stacked in the same orientation and sintered. A plurality of conductive pads are formed on the plurality of conductive paths which are exposed at the first and second ends of the ceramic circuit board.

The method for manufacturing a pitch converting connector according to the present invention comprises the steps of:

a) forming a plurality of conductive paths on the surfaces of a plurality of ceramic green sheets, such that they are at a narrow pitch at first ends of the ceramic green sheets and widen to a wide pitch at second ends thereof;

b) stacking the plurality of ceramic green sheets in the same orientation with respect to one another;

c) sintering the stacked ceramic green sheets to form a ceramic circuit board; and

d) forming conductive pads on the plurality of conductive paths, which are exposed at the first and second ends of the ceramic circuit board.

### BRIEF DESCRIPTION OF THE DRAWINGS

The invention will be described with reference to an embodiment show in the attached figures. The following is a brief description of each figure.

FIG. 1 is a front view of a pitch converting connector according to the present invention.

FIGS. 2A, 2B, and 2C illustrate the manufacturing process for the pitch converting connector of FIG. 1, wherein: FIG. 2A illustrates a ceramic green sheet, on which conductive paths have been formed, prior to sintering; FIG. 2B illustrates a state in which a plurality of the ceramic green sheets are stacked; and FIG. 2C illustrates a state in which the stacked ceramic green sheets have been sintered.

FIGS. 3A, 3B, and 3C illustrate a connector main body 2, wherein: FIG. 3A is a plan view; FIG. 3B is a front view, and FIG. 3C is a bottom view.

FIG. 4 is a partial magnified view illustrating a state in which a pin is soldered onto a conductive pad.

FIGS. 5A and 5B illustrate the arrangement of the pins, which are soldered onto the conductive pads, wherein: FIG. 5A illustrates the arrangement of the pins, which are soldered onto the conductive pads at a first surface of the connector main body; and FIG. 5B illustrates the arrangement of the pins, which are soldered onto the conductive pads at a second surface of the connector main body.

FIG. 6 is a flow chart that illustrates the steps for manufacturing the connector main body.

FIG. 7 is a flow chart that illustrates the steps by which the connector main body is formed into the pitch converting connector.

### DETAILED DESCRIPTION OF THE EMBODIMENTS

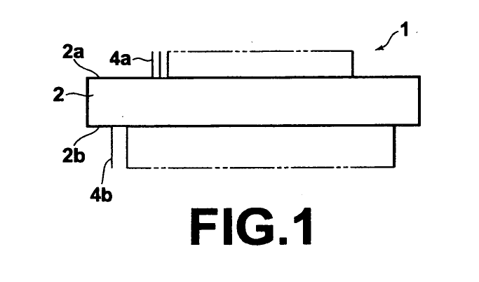

Hereinafter, a pitch converting connector 1 (hereinafter, simply referred to as “connector”) according to an embodiment of the present invention will be described with reference to the attached figures. As illustrated in FIG. 1, the connector 1 comprises a connector main body 2, which is substantially square in plan view a large number of conductive pins 4a, which are relay I/O pins, embedded in a first surface 2a of the main body 2 and a large number of conductive pins 4b, which are also relay I/O pins, embedded in a second surface 2b of the main body 2. The pins 4a and 4b function as electrodes of the connector 1. The connector main body 2 is ceramic (alumina AL 203, for example). The pins 4a are provided at high density and narrow pitch in a matrix arrangement. The pins 4b are provided at a wider pitch than the pins 4a, also in a matrix arrangement. A large number of conductive paths that connect the pins 4a and 4b are provided in the interior of the connector main body 2. The connector 1 is provided within an ultrasound probe of an ultrasound diagnostic apparatus (not shown), interposed between a probe transducer, such as a piezoelectric element, (not shown) that generates ultrasonic waves and wires of the apparatus. That is, the connector 1 converts the narrow pitch of the piezoelectric element to the wide pitch of the wires, to facilitate establishment of electrical connections between the piezoelectric element and the wires.

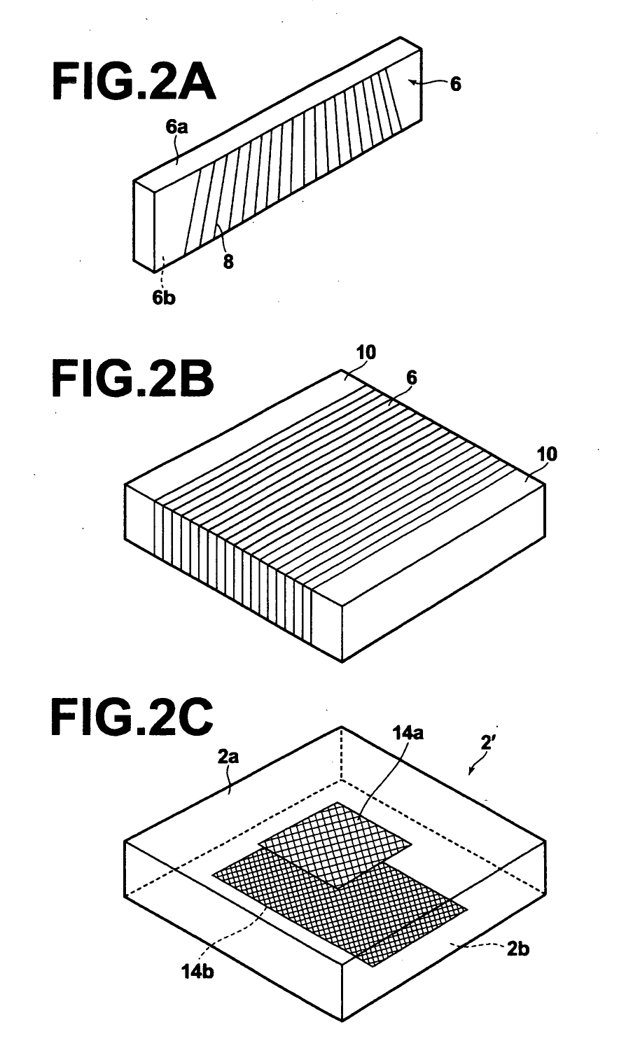

Next, the process by which the connector 1 is manufactured will be described with reference to FIGS. 2A, 2B, and 2C. FIG. 2A illustrates a ceramic green sheet 6, on which conductive paths 8 have been formed, prior to sintering. FIG. 2B illustrates a state in which a plurality of ceramic green sheets 6 are stacked and FIG. 2C illustrates a state in which the stacked ceramic green sheets 6 have been sintered. The green sheet 6 prior to sintering is a comparatively soft rectangular member having a thickness of approximately 0.2 mm. The dimensions in the vertical direction are set, taking shrinkage during sintering into consideration. A plurality of conductive paths 8 are formed from a first edge 6a to a second edge 6b of the green sheet 6.

Note that the conductive paths 8 do not exhibit conductivity until the ceramic is sintered. However, for the sake of convenience, they will be referred to as “conductive paths” regardless of whether sintering has been performed. The conductive paths 8 are formed so as to separate from each other such that they are at a narrow pitch at the first edge 6a and at a wide pitch at the second edge 6b. In other words, the pitch of the conductive paths 8 is converted from a narrow pitch to a wide pitch from the first edge 6a to the second edge 6b. The regions that become the conductive paths 8 are formed by thick film printing tungsten, chrome molybdenum, or molybdenum manganese paste, and become the conductive paths 8 after sintering. There are 64 conductive paths 8 in the present embodiment. However, the number of conductive paths 8 can be greater than or less than 64. The conductive patterns formed on the stacked green sheets 6 are sintered simultaneously with the green sheets 6. Therefore, the conductive paths 8 are formed as continuous conductors, and the pitch thereof becomes even narrower, due to shrinkage of the green sheets 6 during sintering. Accordingly, these conductive paths 8 can be formed at higher density than those formed on resin plates.

Next, the green sheets 6 are stacked in the same orientation, that is, such that the surfaces on which the conductive paths 8 have been formed face the same direction, along the thickness of the green sheets 6. Two additional green sheets that function as pressing members 10 are provided at both ends of the stack, and the stack is sintered while maintaining this configuration. In the present embodiment, 64 green sheets 6 are stacked at this time. After sintering, the stack formed by the green sheets 6 and the pressing member 10 is cured and integrated into a ceramic circuit board 2′, as illustrated in FIG. 2C. The dimensions of the ceramic circuit board 2′ are 35 mm×35 mm×7 mm. 4096 (64×64) exposed portions of the narrow pitch conductive paths 8 are provided in a matrix arrangement within a comparatively small substantially square region 14a at the surface 2a of the ceramic circuit board 2′. The surface 2a corresponds to the first edges 6a of the ceramic green sheets 6. 4096 exposed portions of the wide pitch conductive paths 8 are provided in a matrix arrangement within a substantially rectangular region 14b, which is larger than the region 14a, at the surface 2b of the ceramic circuit board 2′. The surface 2b corresponds to the second edges 6b of the ceramic green sheets 6.

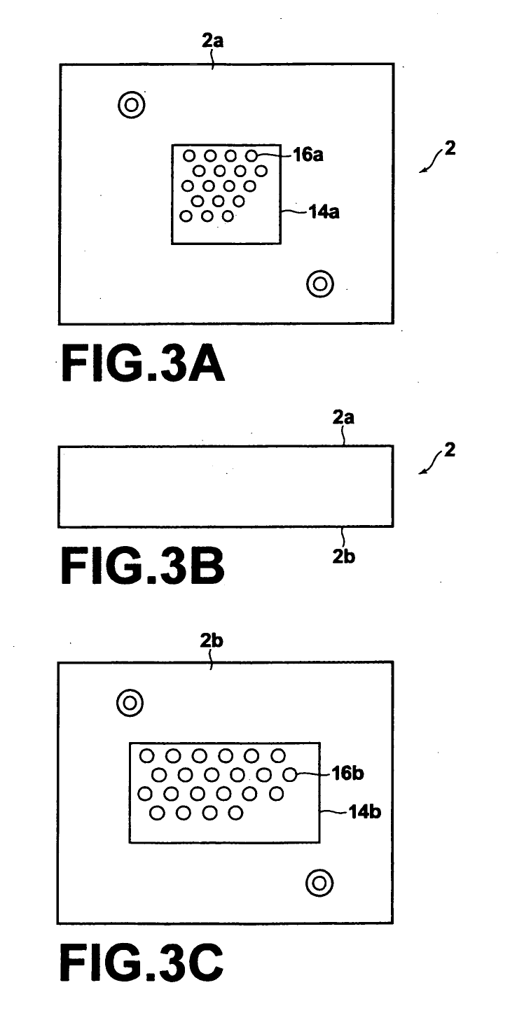

Pads 16 are formed by depositing nickel on the exposed portions of the ceramic circuit board 2′ by vapor deposition, then gold plating the nickel, to form conductive pads 16a and 16b, as illustrated in FIGS. 3A and 3C. Each of the conductive pads 16a are connected to the conductive pad 16b corresponding thereto by the conductive paths 8. FIGS. 3A, 3B, and 3C illustrate the connector main body 2, on which the conductive pads 16 have been formed in this manner. The conductive pads 16 (16a and 16b) are enlarged in FIGS. 3A and 3C, to illustrate their arrangement. However, the conductive pads 16 are extremely small, and are difficult to discern visually in actuality. It is preferable for the conductive pads 16a at the narrow pitch surface 2a to be provided in a staggered matrix at a predetermined pitch, to increase the arrangement density of the conductors. The conductive pads 16b, which are slightly larger than the conductive pads 16a, are provided at a wider pitch than that of the conductive pads 16a.

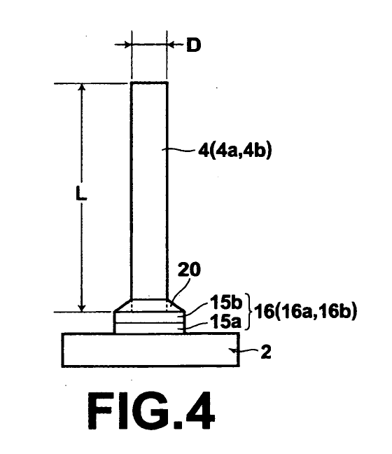

Next, a manufacturing process of the connector 1, in which pins are embedded in the conductive pads 16a and 16b of the connector main body 2, will be described with reference to FIG. 4. FIG. 4 is a partial magnified view illustrating a state in which a pin 4 (4a or 4b) is soldered onto a conductive pad 16 (16a or 16b). The conductive pads 16 of the connector main body 2 comprise a nickel layer 15a and a gold plating layer 15b atop the nickel layer 15a. The pins 4 (4a or 4b) are soldered onto the conductive pads 16 by solder 20, which is a gold/tin alloy. The pins 4a and the pins 4b are soldered onto the conductive pads 16a on the first surface 2a and the conductive pads 16b on the second surface 2b, respectively, as illustrated in FIG. 1. The pins 4a have diameters D of approximately 0.05 mm to 0.12 mm, and lengths L of approximately 1 mm. The pins 4b have diameters D of approximately 0.15 mm to 0.23 mm, and lengths L of 2 mm to 5 mm.

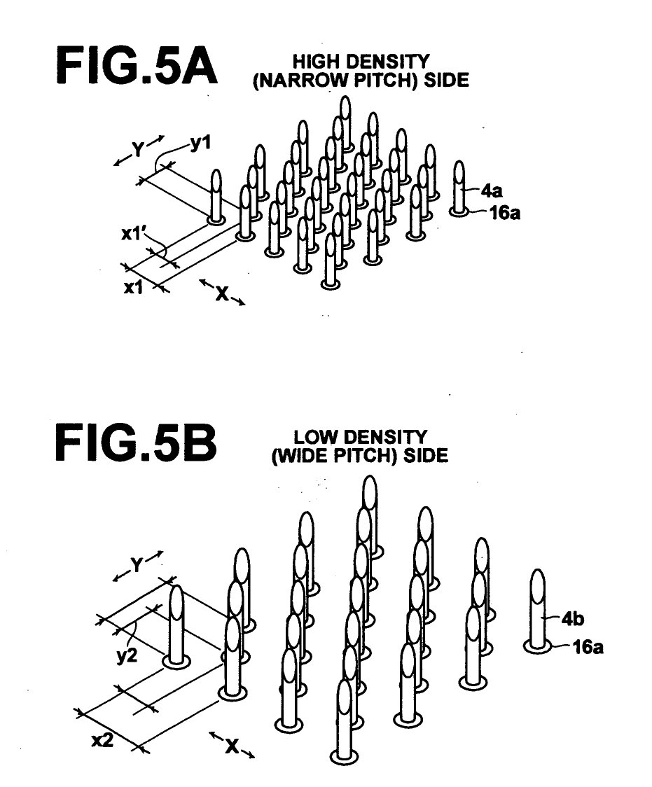

Next, a state in which the pins 4 (4a and 4b) are embedded in the connector main body 2 will be described with reference to FIGS. 5A and 5B. FIGS. 5A and 5B illustrate the arrangement of the pins 4, which are soldered onto the conductive pads 16. The arrangement pitch x1 of the pins 4a in the X direction is 0.2 mm, and the arrangement pitch y1 of the pins 4a in the Y direction is 0.2 mm. The distance of staggering x1′ among adjacent rows of pins 4a is 0.1 mm. The arrangement pitch x2 of the pins 4b in the X direction is 0.4 mm, and the arrangement pitch y2 of the pins 4b in the Y direction is 0.2 mm. That is, the pitch of the pins 4 in the X direction is doubled at the surface 2b, while the pitch in the Y direction remains the same. Accordingly, the substantially square region 14a at the first surface 2a is converted to the elongate rectangular region 14b at the second surface 2b, as illustrated in FIGS. 3A and 3C.

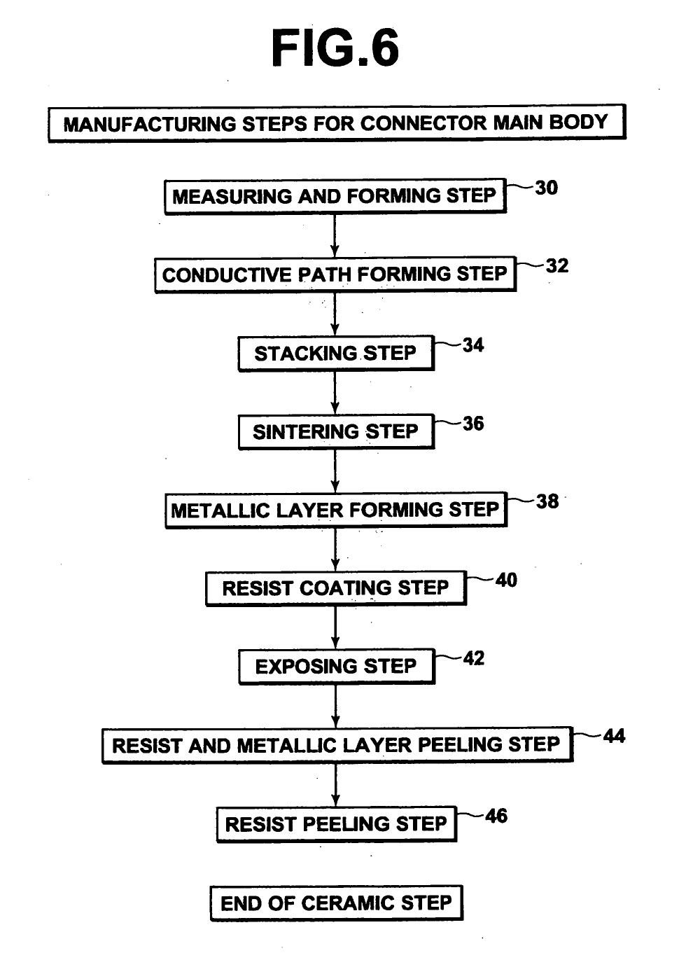

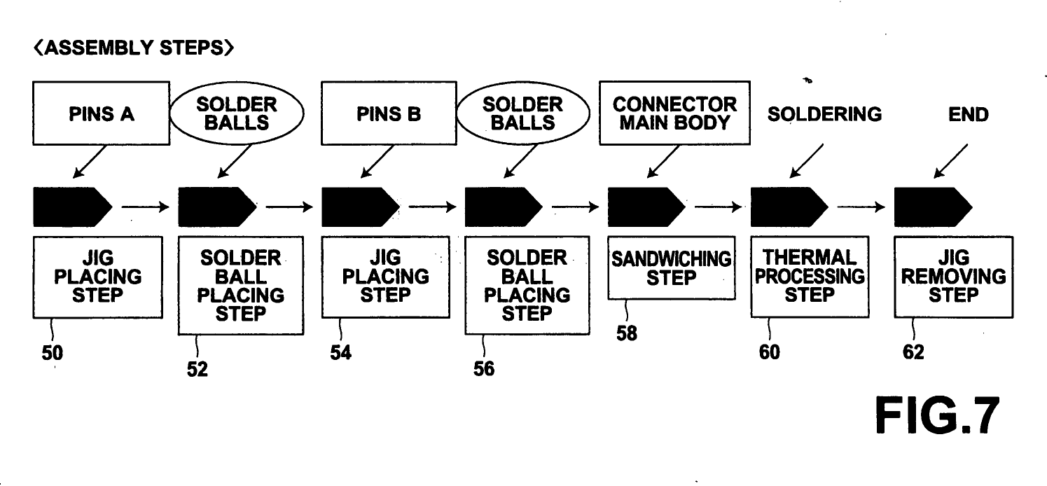

Next, each step in the manufacturing process of the connector 1 will be described with reference to FIGS. 6 and 7. FIG. 6 is a flow chart that illustrates the steps for manufacturing the connector main body 2. FIG. 7 illustrates the steps by which the connector main body 2 is formed into the connector 1. The rigid ceramic circuit board 2′ that contains the conductive paths 8 is manufactured, by: a measuring and forming step 30, in which the green sheets 6 are formed into predetermined dimensions; a conductive path forming step 32, in which conductive patterns of the conductive paths 8 are formed by thick film printing or the like; a stacking step 34, in which the green sheets 6 are stacked; and a sintering step 36, in which the stacked green sheets 6 are sintered and integrated. This represents the steps up to and including the sintering step 36 manufacture the ceramic circuit board 2′.

A metallic film forming step 38, in which metallic layers are formed on the regions 14a and 14b by depositing nickel and gold in this order by vapor deposition, is administered on the ceramic circuit board 2′. The metallic layers become the materials of the pads 16. Next, a resist coating step 40, in which photosensitive materials (resist) are coated on the regions 14a and 14b, is administered. Then, an exposing step 42, in which the resist materials are exposed via a mask having apertures corresponding to the positions of the pads 16, is administered. The exposing step 42 is not limited to this, and a positive or negative resist may be employed. Next, a removing step 44, in which the resist materials and the metallic layers are peeled from portions other than the exposed portions, that is, other than the positions of the pads 16, is administered. Finally, a removing step 46, in which the resist materials are removed from the pads 16, is administered, to complete the ceramic circuit board manufacturing process.

Next, each step in the assembly of the connector 1 will be described with reference to FIG. 7. First, the method for manufacturing the pins 4a and 4b, which are utilized in the steps illustrated in FIG. 7 will be described. A large number of the pins 4a and 4b are manufactured by: cutting a steel/nickel/cobalt alloy (kovar) wire, for example; nickel plating the cut pieces of the wire; and gold plating the nickel plated-pieces of the wire. Gold/tin alloy solder balls for soldering the pins 4a and 4b on to the pads 16 are also prepared.

As illustrated in FIG. 7, the assembly process comprises the following steps. First, a jig placing step 50, in which pins A (the pins 4a, for example), are placed in the holes of a jig (not shown), is performed. The holes of the jig are provided at positions corresponding to the conductive pads 16 of the connector 1, and are configured such that each hole houses a single pin 4a. Then, a solder ball placing step, in which solder balls having diameters of approximately 0.15 mm are placed in the holes of the jig, in which the pins 4a are placed, is performed. In a similar manner, pins B, in this case, the pins 4b, and solder balls are placed in the holes of another jig (not shown), in a jig placing step 54 and a solder ball placing step 56. Next, a sandwiching step 58, in which the jigs are arranged so as to sandwich the connector main body 2 therebetween, is performed. Heat is applied in this state, in a thermal processing step 60. Due to the applied heat, the solder balls melt, and solder the pins 4a and 4b onto the conductive pads 16a and 16b respectively, as illustrated in FIG. 4. The jigs are removed in a jig removing step 62, and the connector 1, in which a great number of the pins 4a and 4b are embedded in the connector main body 2, is completed.

When built in to the interior of the ultrasound probe, for example, the pins 4a of the connector 1 are adhesively attached to the piezoelectric element by conductive adhesives at temperatures of approximately 150° C. However, there is no possibility that the connector 1 will deform, because it is made of ceramic material.

As described in detail above, the connector 1 of the present invention comprises the pins 4a and 4b. Therefore, establishing soldered connections with electric/electronic devices having many connection points at narrow pitches is facilitated. It should be understood that the conductive pads may be alternatively formed as conductive pins or solder balls.

Advantageously, the connector main body is formed by a ceramic material, and therefore it will not deform even if heat is applied thereto. Accordingly, the reliability of electrical connections established thereby is high. In addition, the ceramic circuit board of the pitch converting connector of the present invention is formed by stacking the green sheets, on which similar conductive paths have been formed, in the same orientation, that is, such that the surface of the green sheets that have the conductive paths formed thereon face the same direction, then sintering the stacked green sheets. Therefore, manufacture of the ceramic circuit board is facilitated.

What is claimed is:

1. A pitch converting connector, comprising:
a ceramic circuit board being formed of a plurality of ceramic green sheets; and a plurality of conductive paths extending from a first end to a second end of the ceramic green sheets such that they are at a narrow pitch at the first end and widen to a wide pitch at the second end, the plurality of ceramic green sheets being stacked in the same orientation and sintered; and
a plurality of conductive pads, being formed on the plurality of conductive paths are exposed at the first and second ends of the ceramic circuit board.

2. The pitch converting connector of claim 1 wherein the conductive paths are arranged in a substantially square region on the first end.

3. The pitch converting connector of claim 2 wherein the conductive paths are arranged in a substantially rectangular region on the second end.

4. The pitch converting connector of claim 3 wherein the ceramic circuit board formed of sintered green sheets is integrated into a second ceramic circuit board.

5. The pitch converting connector of claim 1 further comprising conductive pins being soldered to and extending from respective conductive pads.

6. The pitch converting connector of claim 1 wherein the conductive pads are formed by a nickel layer and a gold plating layer.

7. A method for manufacturing a pitch converting connector, comprising the steps of:
a) forming a plurality of conductive paths on the surfaces of a plurality of ceramic green sheets, such that they are at a narrow pitch at first ends of the ceramic green sheets and widen to a wide pitch at second ends thereof;
b) stacking the plurality of ceramic green sheets in the same orientation with respect to one another;
c) sintering the stacked ceramic green sheets to form a ceramic circuit board; and
d) forming conductive pads on the plurality of conductive paths, which are exposed at the first and second ends of the ceramic circuit board.

8. The method of claim 7 further comprising the step of soldering conductive pins to the conductive pads.

9. The method of claim 9 wherein the soldering step comprises the steps of placing the conductive- pins in jig, applying solder balls to each conductive pin, sandwiching the jig onto the ceramic circuit board such that the solder balls are aligned with the conductive pads and thermally processing.
